(19) United States
(12) Patent Application Publication
(10) Pub. No.: US 2013/0214050 A1
(43) Pub. Date: Aug. 22, 2013

(54) SYSTEM AND METHOD FOR PROCESSING SECURITY OR IDENTIFICATION OBJECTS

(71) Applicant: Boris Fruehauf, Roding (DE)

(72) Inventor: Boris Fruehauf, Roding (DE)

(73) Assignee: MUEHLBAUER AG, Roding (DE)

(21) Appl. No.: 13/816,485

(22) PCT Filed: Aug. 12, 2011
(86) PCT No.: PCT/EP2011/004080

§ 371 Date: Mar. 25, 2013

(30) Foreign Application Priority Data
Aug. 13, 2010 (DE) 10 2010 034 167.3

(51) Int. Cl. B25J 9/16; G06K 19/06

(52) U.S. Cl. CPC B25J 9/16; G06K 19/06187
USPC 235/493; 414/222.01; 414/222.13

(57) ABSTRACT

A system for processing security or identification objects, comprising a transfer device which is receives and re-delivers at least one security or identification object. The system includes processing, control, inventory or receiving modules which are arranged on an enclosure having an at least partially closed periphery. The periphery of the enclosures surrounds the space in which the transfer device moves the security or identification objects so that the space in which the security or identification objects are moved and a space surrounding the enclosure are spatially separated from each other. The periphery of the enclosure includes openings through which the transfer device receives the security or identification objects from the surrounding space and delivers same to the surrounding space and through which the supply and/or discharge of the security or identification objects to/from the modules takes place.

### BACKGROUND

A system and a method for processing security or identification objects are described. Security or identification objects can be cards such as, for example, ID cards, EC cards or, alternatively, identity documents such as, for example, personnel identity badges, passports, access documents and other permit documents.

The processing of security or identification objects is normally performed in a production line. In a production line, the security or identification objects are processed and checked in a serial manner. On a conveyor device, the security or identification objects that, at least, are not yet fully processed, are delivered to a first processing station in the production line, where they are processed, and they are then delivered, via the conveyor device, to a further processing or inspection station that, for example, checks the previously processed security or identification object. The processing of a security or identification object is therefore performed in dependence on the preceding processing; i.e. it is only when the preceding processing step has been executed that it is possible to perform the next processing step. Frequently, in order to increase at least the throughput in the case of such processing, a plurality of processing stations are arranged in parallel, and security or identification objects are delivered to these stations via parallel transport devices.

If there is a failure of a processing or inspection station in such a production line, processing has to be interrupted. Both the delivery of security or identification objects, and the individual processing and/or inspection stations, are stopped. It is only when all stations and devices of the production line have been stopped that the fault resulting in the failure can be eliminated. For example, it is possible that printing devices that print the security or identification objects with an ink become clogged, and this clogging must be eliminated. On the other hand, the changing of a printer tape or of a simple wearing part can result in processing being stopped. It is only when the processing operation has been interrupted and all stations and devices have been stopped that the faulty parts/elements or modules can be replaced or inspected.

For safety reasons, however, both the production line and the processing stations must be stopped in the case of inspection, servicing or repair, or their electric power supply must be disconnected, so that there is no injury of any kind to personnel carrying out this work.

In most cases, the stoppage of processing of the security or identification objects has the result that the only partially processed security or identification objects in the production line cannot be used further. One reason for this is that, for example, in the case of the application of adhesives, the adhesives are hardened until further processing is performed. A repair can often take several hours, particularly if an entire processing module has to be removed. No security or identification objects can be processed in the production line during this period.

### PRIOR ART

A production of personalized identity cards is known from DE 37 81 239 T2, the translation of the European patent specification EP 0 266 926 B1. Specified therein is a system for personalization of I.C. microchip cards, which adapts to differing programming times of the microchips without causing unacceptable interruptions in the flow of the cards through the system. For this purpose, the system comprises a multiplicity of serially arranged stations for programming the cards with personal data, the stations being arranged in a circular formation on a rotary table. The rotary table is driven by means of a variable-speed direct current motor and is rotated in only one direction of processing. The system additionally has means for delivering and discharging the cards. The latter are arranged in a stationary manner in immediate proximity to the rotary table. In the case of the method, a card is delivered to a station by the delivery means, and the rotary table is then rotated further by one position, such that a card can be delivered to an adjacent station on the rotary table. As a result, a plurality of cards are programmed simultaneously, and the differing programming times of the microchips do not adversely affect the overall throughput. In addition to the delivery, opposite to the direction of rotation of the rotary table, there is also a discharge system, which receives and discharges the cards from the stations after they have been programmed.

DE 101 10 414 A1 describes a card personalization system and a method for working through card personalization orders. Described therein is a card personalization system and a method for working through a plurality of card individualization orders that provides for a high throughput, and that are additionally suitable for smaller orders with a high throughput. The system has a transport device, which is realized as a rotary disc, and has processing modules, which are arranged around the rotary disc. The system in this case comprises two differing processing units. Particular modules pertain to the first processing unit, and other particular modules pertain to the second processing unit. Depending on their processing units, the modules can be arranged next to each other, or in an alternating manner, i.e. a module of the second processing unit always follows a module of the first processing unit. The modules are arranged in a stationary manner, and the transfer of the cards is effected solely via the rotary disc, which can be moved in only one direction of rotation. The rotary disc transports a card from a first module, which is a card magazine of the first processing unit, to a module that is a processing station of the first processing unit, and transports a card processed by this station to a further module. This operation is continued until all modules and all processing steps have been worked through and the cards have been delivered to the final module, which is likewise is a card magazine. The same applies to the second processing unit. As a result, differing card orders can be worked through in parallel. The exchanging of modules enables the system to be adapted to new orders.

### PROBLEMS OF THE PRIOR ART

Since rotary tables or rotary discs necessarily rotate during the processing of the cards, modules mounted on rotary tables are basically not accessible during the processing of the cards. If a module fails, the rotary table has to be stopped until the failed module has been repaired or replaced.

It is therefore not possible to service, repair or remove modules or parts of the production line during operation without endangering persons and producing rejects.

In addition, rotary table arrangements can only be adapted to new requirements to a limited extent. In particular, it is scarcely possible to alter the processing times, since the latter are fixedly defined by the size of the rotary table, the arrangement of the delivery and discharge systems, and the speed of rotation.

Owing to the dedicated nature of the design of the rotary table, and of the delivery and discharge systems that are also integrated into a production line, variable processing of differing security or identification objects that require differing processing times is therefore not possible.

Although DE 37 81 239 T2 does offer variable processing, or a variable programming time, for card microchips, it is nevertheless inflexible. One card having a programmed microchip is output per work cycle time, i.e. upon each further rotation of the rotary table. However, since the programming time for individual microchips is far less that the time required by the rotary table for one revolution, until the cards are output, not all processing stations are utilized to full capacity. Furthermore, in the case of the method and the system from DE 37 81 239 T2, it is not possible to undertake servicing, repair or replacement of parts of the system without stopping the operation of the system. Servicing, repair or replacement of parts of the system cannot be performed during operation of the system without endangering persons.

The card personalization system disclosed in DE 101 10 414 A1 and the method for working through card personalization orders likewise offers processing that is variable to a very large extent, but it also is dependent on the processing time, since the rotary disc transfers the cards according to a time cycle. This means that the rotary disc may have longer wait times in one position, such that a card cannot be transferred if the card that is to be processed before it has not been completely processed and deposited on the rotary disc by the module. This is additionally extremely problematic in the case of DE 101 10 414 A1, since, in the case of this card personalization system, in which the modules are disposed either in an alternating manner, depending on the processing unit, or also, alternatively, the module blocks are disposed next to each other, according to processing unit. The system uses a common rotary disc, such that the processing of differing processing orders of the different processing units is always effected in dependence on the other order in each case.

In addition, DE 101 10 414 A1 does not offer any possibility enabling the modules or other parts of the system to be replaced, serviced or repaired during operation without endangering persons. Although it is possible to replace the individual processing modules, since the latter are realized as units, it is nevertheless necessary to interrupt processing and stop the system.

Furthermore, the documents of the prior art DE 101 10 414 A1 and DE 37 81 239 T2 disclose transfer of the cards in only one direction of processing. The cards therefore cannot be processed in a variable manner. The disclosed systems can also operate only with one direction of processing/rotation, since, in the case of DE 101 10 414 A1, a variable direction of rotation would render processing of the cards impossible, mainly because two separate processing units are provided (arrangement of card magazine and processing modules) and, in the case of DE 37 81 239 T2, only one encoding system is disclosed, which is designed only for processing in one direction of rotation, and which could not perform its assigned task if there were two directions of rotation.

Since the objects described in the documents DE 37 81 239 T2 and DE 101 10 414 A1 scarcely need to be adapted to new requirements, these objects can only be used to a limited extent for the processing of small batches. If, in addition, it is necessary to convert the device between the processing of differing production lots, the design described in DE 37 81 239 T2 and DE 101 10 414 A1 requires that the device be non-operational during the conversion.

It is known from other technical fields, for example the ordered storage of data carriers, that the use of a robot arm enables movements between the individual storage elements. However, the requirements for such facilities are fundamentally different. Thus, for example, a data carrier store is described in the document U.S. Pat. No. 5,479,581. The data carrier store comprises a plurality of so-called libraries, which comprise data carrier drives, a carrousel for receiving data carriers, and a linear robot arm. A rotary robot arm is provided for exchanging data carriers between the individual libraries. In addition to the data-carrier storage places in the carrousels, further storage places for data carriers are provided between the libraries.

Unlike security or identification objects, however, the data carriers are not processed. Instead, the data carrier store is used for the ordered storage of the data carriers, the access time to the data carriers being particularly relevant. Accordingly, neither processing sequences nor processing times need be taken into account. Moreover, neither the storage spaces for receiving the data carriers nor the drives need to be serviced or repaired, as would be the case, for example, with a printing device for a security or identification object.

The prior art therefore does not disclose any systems that, while maintaining the safety of the persons operating the system, effect variable processing of security or identification objects such as, in the case of the said documents of the prior art, cards having microchips, and that always provide optimised utilization of the capacity of the system.

### Object on Which the Invention is Based

It is therefore the object of the invention to eliminate these disadvantages of the prior art. In particular, it is intended to provide a system and a method that enables the security or identification objects to be processed in a variable manner. In addition, the periods of non-operation caused, for example, by servicing work or repairs, are to be reduced.

### Proposed Solution

Proposed for this purpose is a system comprising a transfer device, which receives and re-delivers a security or identification object, the security or identification object being moved by the transfer device in a multi-dimensional space. A controller serves to control the transfer device. In addition, the system has at least one module, in which the security or identification objects are held in stock, received, processed or inspected. The system further comprises an enclosure having an at least partially closed periphery. The periphery surrounds the space in which the transfer device moves the security or identification objects. As a result, the space in which the security or identification objects are moved and a space surrounding the enclosure are spatially separated from each other. The periphery of the enclosure comprises openings, through which the transfer device receives the security or identification objects from the surrounding space and re-delivers them to the surrounding space, for example through another opening. The security or identification objects are delivered to and/or discharged from the modules through the openings of the enclosure.

Such a system makes it possible for security or identification objects to be processed in a variable sequence, i.e. for the individual processing steps for each security or identification object to be worked through in a different sequence. Also, in the case of such a system, differing processing times of the individual security or identification objects do not result in a module having to wait until it can process a further security or identification object. Since the security or identification objects are delivered and discharged by the transfer device, which moves the security or identification objects to and from the modules without dependence on a processing sequence, all modules can be supplied with security or identification objects at any time.

It is also a substantive advantage of this system that the transfer of the security or identification objects by the transfer device is effected in a space that is not accessible from outside this space. Consequently, servicing, repair or replacement of the modules can be performed while the transfer device is in operation, and during the processing operation. It would therefore also be possible, by adding or removing the modules while the system is in operation, to effect a changeover, from one type of security or identification objects that are to be processed, to another type. In addition, there is a substantive advantage in that persons present in proximity to the system or working on it are not endangered in any way by moving parts of the transfer device.

In addition, the variable delivery and discharge of the security or identification objects enables differing security or identification objects to be processed simultaneously in the system. Thus, security or identification objects of a first production batch, i.e. security or identification objects that undergo the same processing steps, can be processed in the system independently of security or identification objects of a second production batch, i.e. security or identification objects that undergo at least one other processing step. For this purpose, a first module group, for processing the first production batch, and a second module group, for processing the second production batch, can be provided in the system. Accordingly, differing production batches can be processed in parallel by means of the system, i.e. independently of each other. Depending on the capacity utilization of the individual modules, modules can also be provided for processing the first and the second production batch. Thus, for example, for processing steps of short duration, a common module can be provided for the first and the second production batch, while two or more separate modules are provided for processing steps of long duration. Further, it is possible for the first module group to be serviced or to be converted for a third production batch while the second module group is processing security or identification objects.

The system for processing security or identification objects enables the security or identification objects to be processed in a variable manner, i.e. both in the processing sequence and in the processing period, and processing modules can be replaced, added or removed while the system is operating, and the security or identification objects can be processed, without any risk to persons, without movable parts being accessible by persons and/or without the production of rejects. Moreover, the system is also suitable for orders that have a smaller number of security or identification objects to be processed, and enables the security or identification objects to be processed in an efficient manner. Moreover, such a system excels in its simple and space-saving configuration.

In one embodiment of the system, the enclosure has receivers for receiving and carrying the modules, which are arranged on the side opposite the transfer device and are located in the space surrounding the enclosure.

In one embodiment, the transfer device of the system is realized to detect the presence of modules at the openings of the enclosure, by means of suitable detection devices. The modules are thus identified automatically. The modules are therefore also integrated automatically into the processing.

One embodiment variant provides that a plurality of modules, for receiving, holding in stock, processing and inspecting security or identification objects, are arranged at differing openings of the enclosure. If a plurality of modules are arranged on the enclosure, a compact system is achieved. This requires less space than known production lines.

In a further embodiment, the system comprises an interface device, which is connected to the controller of the transfer device and to the modules. The interface device enables the transfer device and the modules to be controlled. It can be used to effect processing changes while the system is in operation. The delivery and discharge of the security or identification objects to the respective modules is supported by the automatic identification of the modules.

In addition, a plurality of like modules, which execute the same processing steps, can be mounted on the enclosure. In the event of failure of one module, the security or identification object is automatically transferred to a module arranged at a different location, which performs the same processing steps. This, likewise, is to a large extent effected automatically, since the presence of modules is detected.

The modules mounted on the enclosure of the system are detachable from the enclosure even while the transfer device is in operation. This enables modules to be replaced at any time, or the system to be converted.

In a further embodiment, the enclosure, relative to an opening through which a security or identification object is moved from a module to the transfer device or vice versa, has at least one further opening, through which a security or identification object is moved from the transfer device to the one module or vice versa.

The modules can likewise be controlled by the controller.

In one embodiment variant, the base of the enclosure has a round shape. For example, the base forms the shape of a circle.

In a further embodiment variant, the base of the enclosure has the shape of a closed polygon. In this case, the base of the enclosure can have the shape of a square. In addition, it is possible for the base to have the shape of a rectangle. Also conceivable are the shape of a triangle, both equilateral and isosceles, or other triangular shapes.

In further embodiments, the base of the enclosure has the shape of an equilateral polygon having an even number of corners, such as, for example, six, eight, ten or twelve corners. Likewise, the base of the enclosure can have the shape of an equilateral polygon having an odd number of corners, for example, five, seven, nine or eleven corners. In further, different embodiments, the base of the enclosure also has differing side lengths. For example, in the case of a closed polygon, the base of the enclosure has a side of a particular length that is located between two sides of the closed polygon that are of a greater length than the particular side length. In the case of this embodiment, this arrangement is continued, such that a shorter side always follows a longer side. Other embodiments of the base are likewise possible, however.

In further embodiments, the enclosure of the system has vertical walls. Moreover, the side walls can also be realized in a sloped manner.

In one embodiment variant, the enclosure has a closable opening. This opening can be arranged in the region located close to the base of the enclosure. The closable opening provides access to the transfer device, for the purpose of performing servicing work, or, alternatively, also serves for the removal of defective security or identification objects, dropped by the transfer device or ejected from the modules, from the space in which the security or identification objects are moved. In one embodiment, the enclosure has two closable openings, behind which, in the space in which the security or identification objects are moved, containers are arranged. As a result, a container can be emptied while the transfer device is in operation, while the transfer device or the modules deposit or eject the defective security or identification objects into the respectively other container. In this case, an appropriate device also detects the presence of the containers, and controls the transfer device and the modules such that, in the absence of a container, defective security or identification objects are delivered into the respectively other container.

In further embodiments, the shape of the openings of the enclosure through which the security or identification objects are moved corresponds approximately to the shape of a security or identification object.

In further embodiments, the modules are card magazines, encoding stations in which a chip of a security or identification object is encoded, encoding stations in which a magnetic strip of a security or identification object is encoded, embossing, stamping and/or cutting stations in which a security or identification object is provided with features that can be sensed haptically, printing stations in which a security or identification object is printed, and/or inspection stations in which the security or identification objects are checked for defects before, after and/or during processing thereof.

In other embodiments, a plurality of systems constitute a composite system, in which a plurality of systems are connected to each other via transport devices, such that security or identification objects are transferred from one system to another system, and processing is effected in a plurality of systems.

In the case of a method for processing security or identification objects, a security or identification object is removed by a transfer device from a module in which the security or identification object is held in stock. The security or identification object is then delivered by the transfer device to a further module, in which a first processing step is effected. After the first processing step, the security or identification object is received by the transfer device from the further module and delivered to other, further modules, in which at least one second processing step is effected. The completely processed security or identification object is then delivered by the transfer device to a module in which the security or identification object is received. In the case of this method, the security or identification object is moved by the transfer device in a multi-dimensional space surrounded by an enclosure having an at least partially closed periphery, and is delivered to the modules and/or discharged from the modules by the transfer device into a space that surrounds the enclosure and in which the modules are arranged, through openings in the periphery of the enclosure. The processing steps in this case are effected in a predefined sequence, or at least one processing step is predefined and the other processing steps are effected in a variable manner, or all processing steps are effected in a variable sequence. In a serial process, the security or identification object would pass through a module that is not necessary for processing. In such a case the security or identification object becomes soiled unnecessarily and is subjected to wear. By contrast, the system and method described deliver security or identification objects only to modules in which processing is effected.

In the processing steps, the security or identification objects can be processed and/or inspected.

The method for processing security or identification objects enables the security or identification objects to be processed in a variable manner, i.e. both in the processing sequence and in the processing period, and processing modules can be replaced, added or removed while the system is operating, and the security or identification objects can be processed, without any risk to persons, without movable parts being accessible by persons and/or without the production of rejects. By means of the method, orders that have a smaller number of security or identification objects to be processed can be worked through in an efficient manner.

In the case of the method, a first security or identification object of a first production batch can be processed independently of a second security or identification object of a second production batch. The processing of the first and second security or identification object can be effected in parallel in this case.

In the case of one method, a test run is first performed with a defined number of security or identification objects. In this case, the processing/inspection times are recorded, and the processing time is determined on the basis of the recorded processing/inspection times.

In the case of one method, the presence of modules on the enclosure is detected by means of suitable detection devices.

In the case of a further method, in the case of absence of a module the transfer device transfers the security or identification object to a module located at a different position, which performs the same processing/inspection steps.

In the case of one method, in at least one processing/encoding step a chip of a security or identification object is encoded, a magnetic strip of a security or identification object is encoded, a security or identification object is printed, a security or identification object is provided with features that can be sensed haptically, and/or a security or identification object is checked for defects before, after and/or during processing thereof.

### BRIEF DESCRIPTION OF THE DRAWINGS

Further aims, features, advantages and application possibilities are given by the following description of embodiments, which are to be understood to be non-limiting, with reference to the associated drawings. In this context, all features described and/or depicted, in themselves or in any combination, constitute the subject-matter disclosed herein, including irrespective of their grouping in the claims or their references. The dimensions and proportions of the components shown in the figures are not necessarily true to scale in this case; in the case of embodiments to be implemented, they may differ from that which is represented.

FIG. 1 shows, in schematic form, the top view of the transfer device and the enclosure of a system.

FIG. 2 shows, in schematic form, a perspective view of a transfer device and an enclosure of a system.

FIG. 3a shows, in schematic form, the perspective view of an enclosure having a round base.

FIG. 3b shows, in schematic form, the perspective view of an enclosure having a triangular base.

FIG. 3c shows, in schematic form, the perspective view of an enclosure having a square base.

FIG. 3d shows, in schematic form, the perspective view of an enclosure having a rectangular base.

FIG. 4a shows, in schematic form, the top view of a portion of an enclosure having an opening.

FIG. 4b shows, in schematic form, the perspective view of a portion of an enclosure having an opening and having a security or identification object present in the opening.

FIG. 4c shows, in schematic form, a top view of a portion of an enclosure having a round base, and a security or identification object present in the opening of the enclosure.

FIG. 5 shows, in schematic form, a perspective view of an enclosure having openings and an interface device.

FIG. 6 shows, in schematic form, a perspective view of a system for processing a security or identification object.

FIG. 7 shows, in schematic form, a top view of a composite system.

### DETAILED DESCRIPTION OF THE EMBODIMENT VARIANTS

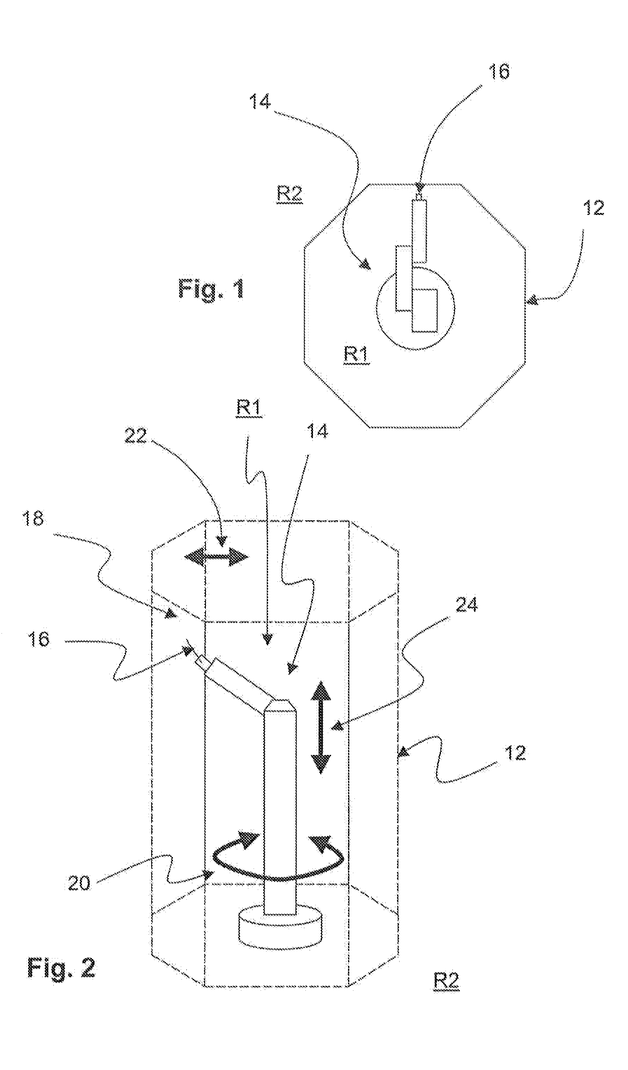

The description that follows presents systems 10 for the processing of cards 18. The cards 18 described here also pertain to the security or identification objects 18, for which reason the same reference (18) is used for both terms. Represented in FIG. 1 is a transfer device 14 and an octagonal enclosure 12 of a system 10 for processing security or identification objects 18, or cards 18. The enclosure 12 surrounds the space R1, in which the cards 18 are moved by a transfer device 14, which in this example is a multi-axial robot. At its working end, the multi-axial robot has a gripper 16 that is realized to receive and re-deliver cards 18, moving them in the space R1. The transfer device 14 can also be a different device realized to receive cards 18, move them in the multi-dimensional space R1 and re-deliver them. For example, the transfer device 14 is a table that can be moved in three directions, a vertically and rotationally freely movable rotary disc, or a device having a plurality of distributor arms. All transfer devices 14 are capable of receiving cards 18 from modules (32) (not represented in FIG. 1) that are mounted on the enclosure 12 and located in the space R2, and re-delivering them to another module 32. The modules 32 are located on the outer walls of the enclosure 12, in the space R2. These modules can be mounted at differing heights, such that the transfer devices 14 have to move the cards 18 both horizontally and vertically in the entire space R1.

A card buffer store (not represented) can be arranged between the transfer device 14 and a module 32 or on the transfer device 14. Consequently, the transfer device 14 has a plurality of cards 18 held in stock for transfer. Some of the cards 18 are at least partially processed cards 18 or non-processed cards 18 from the card magazine. A space R2 surrounds the enclosure 12 and is spatially separated from the space R1 by the enclosure 12. Owing to this separation, it is not possible for persons present in the space R2 to reach into the space R1 or to come into contact with moving parts, for example with the transfer device 14.

The perspective view of a transfer device 14 and a hexagonal enclosure 12 of a system 10 is represented in schematic form in FIG. 2. In order to provide a clearer representation of the transfer device 14, the enclosure 12 is represented by broken lines. It can be seen in this representation that the transfer device 14 moves the cards 18 within the space R1. The arrows 20, 22 and 24 denote the movement of the transfer device 14, and the movement of the card 18 held by a gripper 16 of the transfer device 14. The enclosure 12 spatially separate the space R1, in which the cards 18 are moved by the transfer device 14, from the space R2, which surrounds the enclosure 12. In the embodiment shown, the enclosure 12 encloses only the space R1. In this embodiment, the base of the enclosure 12 can likewise be of a closed design, such that it separates the space R1 from the space R2. By contrast, in this embodiment, the top of the enclosure 12 need not be closed; i.e. the space R1 and the space R2 need not be spatially separated from each other at the location of the top of the enclosure 12.

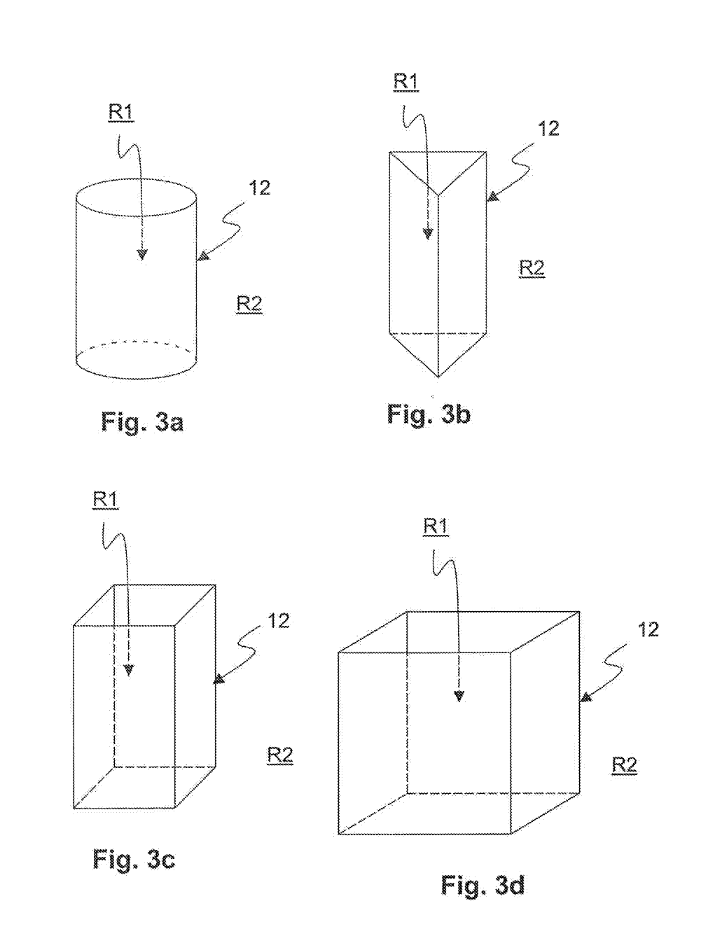

Various designs of the enclosure 12 are represented exemplarily in FIGS. 3a to d. The embodiments shown are represented merely in schematic form. The enclosure 12 in FIG. 3a has a round, circular base and a periphery that is perpendicular thereto. FIG. 3b shows an embodiment of the enclosure 12 having a triangular base and a periphery that is perpendicular thereto. FIG. 3c and FIG. 3d show an enclosure 12 having a rectangular base and a periphery that is perpendicular thereto. The base of the enclosure 12 in FIG. 3c is square.

In the case of all shown embodiments of the enclosure 12, the space R1 is spatially separated from the space R2, at least by the periphery of the enclosure 12. The top of the enclosure 12 therefore does not spatially separate the space R1 from the space R2. Since, when the system 10 is in operation, in the case of the examples shown the system stands on the base of the enclosure 12, the space R1 is adequately separated from the space R2 solely by the periphery of the enclosure 12.

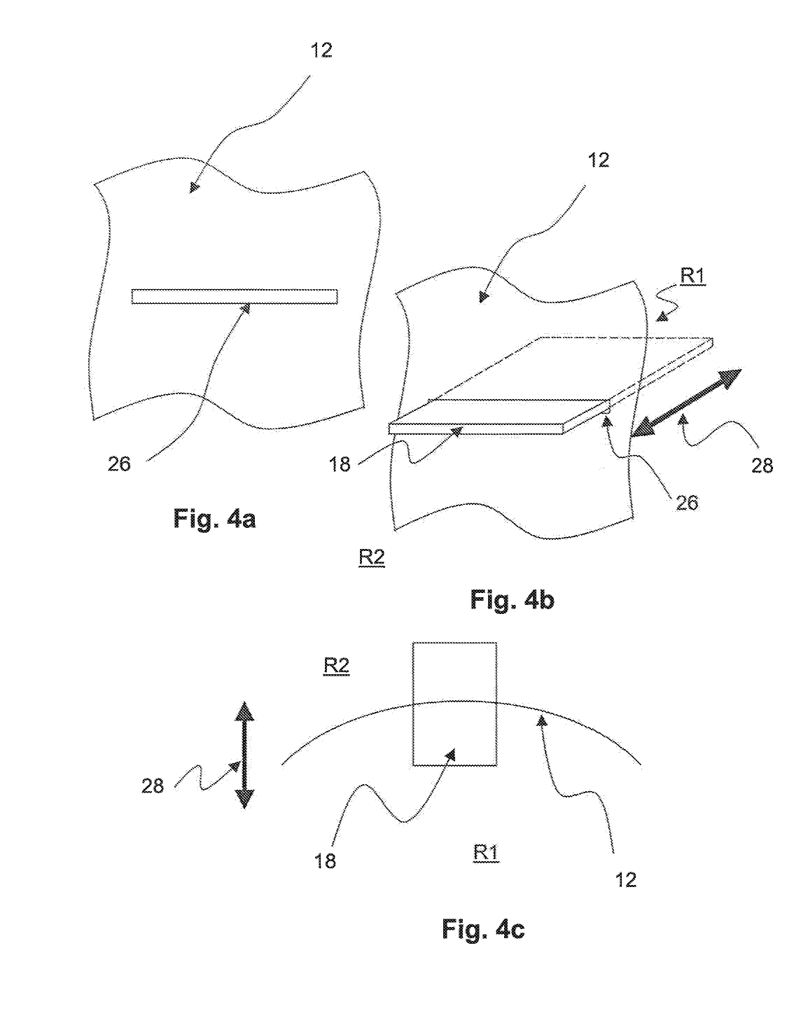

FIG. 4a shows a portion of the enclosure 12. In this portion there is an opening 26, through which the cards 18 are moved between the two spaces R1 and R2. The opening 26 is shaped such that a card 18 can be moved through the opening 26. When there is a card 18 present in the opening 26, the distance between the surfaces of the card 18 and the periphery of the opening 26 that delimits the opening 26 is only sufficiently large to enable the card 18 to be moved through.

FIG. 4b shows a perspective view of a portion of the enclosure 12 having an opening 26. Present in the opening 26 there is a card 18, which can be moved through the opening 26 from the space R1 into the space R2, or vice versa. The arrow 28 shows the direction of movement of the card 18. It can be seen in this representation that the card 18 does not bear on the edge, or periphery, of the opening 26. The card 18 is moved through the opening 26 without contacting the enclosure 12. In other embodiments of the system 10, the cards 18 do contact the enclosure 12 as they are moved through, and are therefore at least partially supported by the enclosure 12 when being transferred.

The openings 26 of the enclosure 12 can be designed, however, such that all security or identification objects 18 provided for processing in this system 10 can be moved through. The enclosure 12 can also have differing openings 26, which correspond to the respective form and shape of the security or identification objects 18. The transfer device 14 and the modules 32 then transfer the security or identification objects 18 only through the openings 26 corresponding to the respective security or identification objects.

FIG. 4c shows, in schematic form, the top view of a portion of an enclosure 12 having a round base and having a card 18 present in the opening 26 of the enclosure 12. The card 18 is moved through the opening 26 (not represented in FIG. 4c) from the space R1 into the space R2, or vice versa. An arrow 28 denotes the possible directions of movement of the card 18.

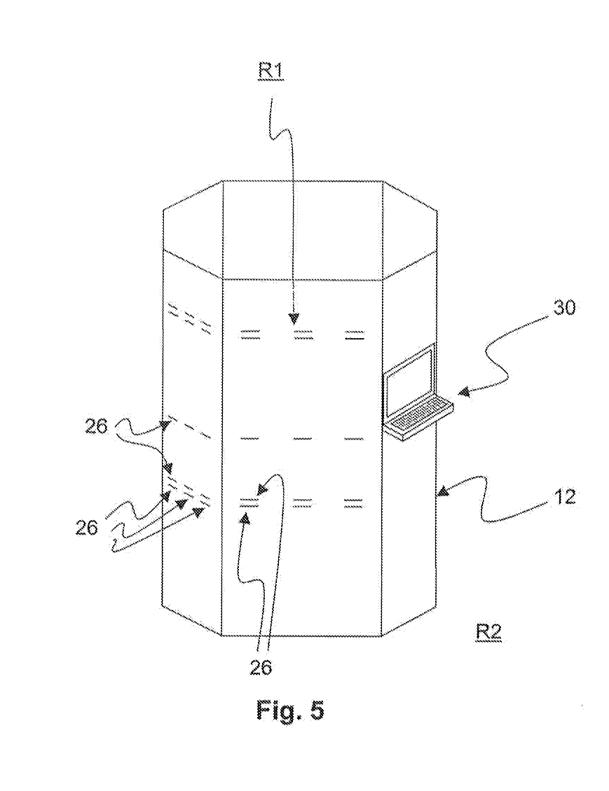

Represented in FIG. 5 is an enclosure 12 having an interface device 30 mounted on the enclosure 12. In addition, the enclosure 12 has openings 26. In the case of FIG. 5, the interface device 30 consists of a keyboard, by means of which the operating personnel can alter the control of the transfer device 14 and of the modules 32 (neither are represented in FIG. 5) and can effect inputs, a monitor screen, which displays information, and a control unit of the interface device 30. The openings 26 are arranged at defined positions of the enclosure 12. The modules 32 are mounted at the positions of the openings 26. When the system 10 is in operation, the cards 18 are then delivered by the transfer device 14, via the openings 26, directly to the modules 32, which re-deliver the cards to the transfer device 14 following processing and/or inspection.

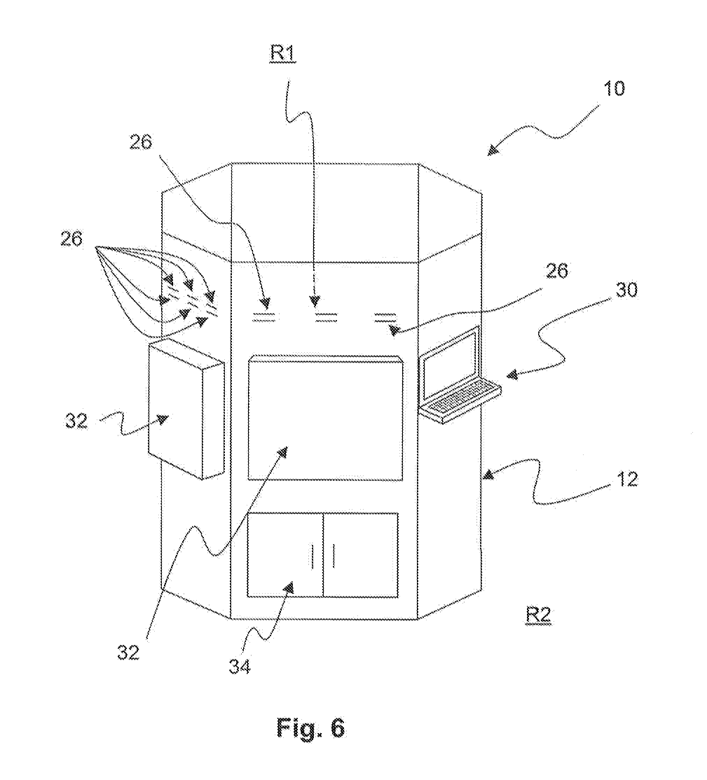

A system 10 of an embodiment variant is represented in FIG. 6. This system comprises an enclosure 12 having openings 26, through which cards 18 are transferred by the transfer device (not represented in FIG. 6) to modules 32 and away from the modules 32. The modules 32 are arranged on the periphery of the enclosure 12, in the space R2. The modules 32 are located at the openings 26 of the enclosure 12, such that the cards 18 are transferred, through the openings 26, directly to the corresponding module 32, or are received by the transfer device 14 from the module 32. The modules are detachably mounted on the enclosure 12 by means of receivers (not represented). The modules 32 can therefore be removed from the enclosure 12 while the transfer device 14 is in operation. The modules 32 comprise card magazines in which non-processed cards 18 are held in stock and the cards 18 can be removed singly from the transfer device 14, or card magazines in which the completely processed cards 18 are deposited by the transfer device 14. In addition, magazines can also be provided for receiving defective cards 18. Further, the modules 32 comprise printing stations, in which cards 18, or security or identification objects 18, are printed. The modules 32 comprise both encoding stations in which magnetic strips of cards 18 are encoded, and encoding stations in which microchips of cards 18 are encoded. The modules 32 also comprise inspection stations, in which the at least partially processed cards 18 are checked. The modules 32 also comprise stations in which the cards 18 are provided with haptic features such as, for example, a protuberance or depression. However, the modules 32 can also comprise modules 32 that perform other processing operations such as, for example, applying laser inscriptions to the cards 18.

When the cards 18 are being processed in the system 10, a card 18 is first removed from a card magazine by the transfer device 14. The transfer device 14 delivers this card 18 to a module 32, in which a first processing is effected. The card 18 is then received back by the transfer device 14 and delivered either to a further module 32 for processing or for inspection. The card 18 is delivered to and discharged from the corresponding modules 32 until the card 18 has been completely processed and checked. The one card 18 is then delivered to a card magazine, in which the completely processed and inspected cards 18 are collected. During the processing of the one card 18, the transfer device 14 receives other cards 18 from the card magazine. These cards 18 are delivered by the transfer device 14 to other modules 32 in dependence on the availability of the modules 32, such that all modules 32 perform a processing operation and/or inspection, and the cards 18 are processed without intermediate wait times. The sequence of the processing and/or inspection steps of the respective cards 18 is effected in a predefined sequence, or in a sequence in which at least one processing and/or inspection step is defined and the other processing and/or inspection steps are effected in a variable manner or, alternatively, in a fully variable sequence of the processing and/or inspection steps.

In one embodiment variant, at least two module groups are provided in a system 10, by means of which module groups at least two differing production batches are processed. The first and the second module group can each comprise separate card magazines, printing stations, encoding stations and inspection stations, such that the first and the second production batch can be processed independently of each other. In this case, the transfer device 14 can, for example, alternately transfer a card 18 of the first production batch and a card 18 of the second production batch.

In a further embodiment variant, at least two module groups are provided in a system, by means of which module groups at least two differing production batches are processed. In this case, the first and the second module group can comprise, for example, common card magazines, printing stations, encoding stations and inspection stations. For the first production batch, a station can additionally be provided in which the cards 18, for example after the encoding operation, are provided with haptic features. The cards 18 of the second production batch skip this processing step, and after the encoding operation are delivered to the inspection station.

In a further embodiment variant, at least two module groups are provided in a system, by means of which module groups at least two differing production batches are processed. Here, likewise, the first and the second module group comprise common stations such as, for example, a common card magazine and a common inspection station. The printing stations and the encoding stations, i.e. stations in which processing steps of longer duration are executed, can each be provided separately. It is additionally possible in this case that, after the first production batch has been worked through, the printing station and the encoding station of a module group are also used for processing the second production batch.

Thus, through the addition of one or more modules, the system can easily be converted/equipped for parallel processing of differing production batches.

In order to determine the processing time for particular cards 18, a test run is performed with a defined number of cards 18. The recorded times are used for determining the total processing time or for optimising the operational sequence of the system 10.

The enclosure 12 additionally has a closable opening 34. The closable opening is used to remove from the space R1 defective cards 18 that have been dropped by the transfer device 14 or ejected from the modules 32. Furthermore, the closable opening 34 provides access to the transfer device 14, for servicing work, repairs or for replacement of parts of the transfer device 14. Containers (not represented), which receive defective cards 18, can also be arranged in the space R1. If two containers are used, when the one container is being emptied the defective cards 18 are transferred into the respectively other container. In this case, an appropriate detection device detects the presence of the two containers, or the non-presence of the one container. In addition, mounted on the enclosure 12 is an interface device 30, which consists of a keyboard, by means of which the operating personnel can alter the control of the transfer device 14 (not represented in FIG. 6) and of the modules 32 and can effect inputs, a monitor screen, which displays information, and a control unit of the interface device 30.

The system 10 further comprises suitable detection devices, by means of which the transfer device 14 or the controller detects that there are modules 32 present at the enclosure 12. It is also detected which module 32 is present in this case. If a module 32 is removed from the enclosure 12 while the transfer device 12 is in operation, the controller of the transfer device 14 causes the transfer device 14 to transfer the card 18, that is to be delivered to this module 32, to a module 32 that performs the same processing and/or inspection steps, and which is arranged at a different location on the enclosure 12.

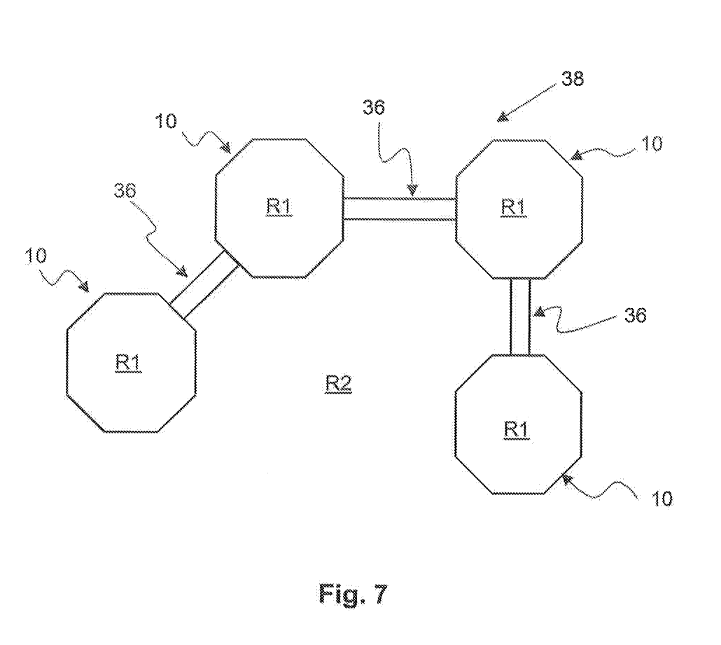

FIG. 7 shows a composite system 38, which consists of four systems 10. The individual systems 10 in this case are connected to each other via transport devices 36. At least two systems 10 of the composite system 38 are always connected to each other, such that cards 18 can be transferred from one system 10, via the transport devices 36, to a system arranged as a final system in the series of systems 10. In other embodiments, two systems 10 constitute a composite system 38. It is also possible, however, for an optional number of systems 10 to pertain to a composite system 38. Furthermore, one system 10 can be arranged centrally in the composite system 38 and transfer the cards to the further systems 10. In one embodiment, only an inspection, or determination of the processing status of the cards 18, is effected in this central system 10, such that the transfer to the respective systems 10 is effected in dependence on which processing steps are still required, and on the capacity utilization of the other systems 10. In a further embodiment, only like processing steps are performed in the individual systems 10 of the composite; for example, in one system 10 the cards 18 are printed, and in another system 10 only the encoding of a chip of the cards 18 is effected.

1. A system for processing security or identification objects, comprising:
at least one transfer device, which receives and re-delivers at least one security or identification object, the security or identification object being moved by the transfer device in a multi-dimensional space,
at least one module, the at least one module being a processing module,
a controller that controls the transfer device, and
an enclosure having an at least partially closed periphery, the periphery;
at least surrounding the multi-dimensional space in which the at least one transfer device moves the security or identification objects, such that the multi-dimensional space in which the security or identification objects are moved and a surrounding space surrounding the enclosure are spatially separated from each other, and
having openings, through which the at least one transfer device receives the security or identification objects from the surrounding space and re-delivers them to the surrounding space, and the delivery and/or discharge of the security or identification objects to/from modules being effected through the openings, and the at least one module being arranged on the periphery, in the surrounding space surrounding the enclosure.

2. The system according to claim 1, characterized in that the enclosure has receivers for receiving and carrying the modules, which are arranged on the side opposite the transfer device and are located in the surrounding space surrounding the enclosure, and/or the transfer device detecting the presence of the modules at the openings of the enclosure, by means of suitable detection devices.

3. The system according to claim 1, characterized in that a plurality of the modules, for receiving, holding in stock, processing and inspecting the security or identification objects, are arranged at differing openings of the enclosure, and/or the system comprises an interface device, which is connected to the controller of the transfer device and to the modules, and by means of which the transfer device and the modules can be controlled, and/or a plurality of like module, which execute the same processing steps, are mounted on the enclosure, the modules of the enclosure being detachable from the enclosure even while the transfer device is in operation, and/or the enclosure, relative to an opening through which the security or identification object is moved from a module to the transfer device or vice versa, having at least one further opening, through which the security or identification object is moved from the transfer device to the one module or vice versa.

4. The system according to claim 1, characterized in that the modules can also be controlled by the controller.

5. The system according to claim 1, characterized in that a base of the enclosure has a round shape or the shape of a closed polygon, and/or the enclosure has sloped or vertical walls and/or a closable opening.

6. The system according to claim 1, characterized in that a shape of the openings of the enclosure corresponds approximately to a shape of the security or identification object.

7. The system according to claim 1, characterized in that the at least one module additionally comprises an inspection, stock-holding or receiving module.

8. The system according to claim 1, characterized in that
the at least one module is a card magazine, and/or
in the at least one module a chip of the security or identification object is encoded, and/or
in the at least one module a magnetic strip of the security or identification object is encoded, and/or
in the at least one module the security or identification object is printed, and/or
in the at least one module the security or identification object is provided with haptic features, and/or
in the at least one module the security or identification objects are checked for defects before, after and/or during processing thereof.

9. The system according to claim 1, wherein a plurality of the systems are connected to each other via transport devices.

10. A method for processing security or identification objects, comprising the steps:
removal of a security or identification object by at least one transfer device from a module in which the security or identification object is held in stock,
delivery of the one security or identification object by the transfer device to a further module, in which a first processing step of the security or identification object is effected,
after the first processing step, receiving of the security or identification object by the transfer device from the further module and delivery and to other, further modules, in which at least one second processing step of the security or identification object is effected,
delivery of the completely processed security or identification object by the transfer device to a module in which the security or identification object is received,
the security or identification object being moved by the transfer device in a multi-dimensional space surrounded by an enclosure having an at least partially closed periphery, and the security or identification object being delivered to the modules and/or discharged from the modules by the transfer device into a surrounding space that surrounds the enclosure and in which the modules are arranged, through openings in the periphery of the enclosure, and the processing steps
being effected in a predefined sequence, or
at least one processing step being predefined and the other processing steps being effected in a variable manner, or
the processing steps being effected in a variable sequence.

11. The method according to claim 10, characterized in that a test run is performed with a defined number of security or identification objects, the processing/inspection times being recorded, and the processing time being determined on the basis of the recorded processing/inspection times.

12. The method according to claim 10, characterized in that the transfer device detects the presence of the modules by means of suitable detection devices, and/or in the case of absence of a module the transfer device transfers the security or identification object to a module located at a different position, which performs the same processing/inspection steps.

13. The method according to claim 10, characterized in that, in at least one step
a chip of the security or identification object is encoded, and/or
a magnetic strip of the security or identification object is encoded, and/or
a the security or identification object is printed, and/or
a the security or identification object is provided with haptic features, and/or
the security or identification objects are checked for defects before, after and/or during processing thereof.
